(19) United States
(12) Patent Application Publication
(10) Pub. No.: US 2026/0077953 A1
(43) Pub. Date: Mar. 19, 2026

(54) METHOD AND APPARATUS FOR AUTOMATICALLY CONTROLLING AT LEAST TWO DRIVABLE BELTS IN A SYSTEM

(71) Applicant: KRONES AG, Neutraubling (DE)

(72) Inventors: Christian Depner, Silberstedt (DE); Niels Clausen, Dollerup (DE); Hanna Dibbern, Bordesholm (DE); Jens Luecke, Flensburg (DE)

(21) Appl. No.: 19/108,698

(22) PCT Filed: Aug. 3, 2023
(86) PCT No.: PCT/EP2023/071528

§ 371 Date: Mar. 4, 2025

(30) Foreign Application Priority Data
Sep. 6, 2022 (DE) 10 2022 122 531.3

(51) Int. Cl. B65G 15/22; B65G 43/08

(52) U.S. Cl. CPC B65G 15/22; B65G 43/08; B65G 2201/0235; B65G 2203/044; B65G 2811/097

(57) ABSTRACT

The invention relates to a method for automatically controlling at least two drivable belts in a system. The belts are each configured to transport containers in a first or second direction. The system comprises a machine that is upstream of the belts and/or a machine that is downstream of the belts. The method comprises: detecting a first operating state of the upstream machine and/or detecting a second operating state of the downstream machine; furthermore determining a speed to be selected for each of the belts based on the first and/or second operating state; and controlling the belts in accordance with the speed to be selected. The invention also relates to an apparatus for carrying out the method, wherein the system comprises a machine that is upstream of the belts and/or a machine that is downstream of the belts.

### CROSS REFERENCE TO RELATED APPLICATIONS

The present application is a U.S. National Phase of International Application No. PCT/EP2023/071528 entitled “METHOD AND DEVICE FOR AUTOMATICALLY CONTROLLING AT LEAST TWO DRIVABLE BELTS IN A SYSTEM,” and filed on Aug. 3, 2023. International Application No. PCT/EP2023/071528 claims priority to German Patent Application No. 10 2022 122 531.3 filed on Sep. 6, 2022. The entire contents of each of the above-listed applications are hereby incorporated by reference for all purposes.

### TECHNICAL FIELD

The invention relates to a method and apparatus for automatically controlling at least two drivable belts in a system according to the independent claims.

### BACKGROUND AND SUMMARY

### Prior Art

DE 31 19 990 A1 discloses a method for determining the filling level of buffer sections between vessel treatment machines for the purpose of controlling the throughput of machines and conveyors in a vessel treatment plant.

In general, buffer systems are unable to react independently to malfunctions in a filling line in order to optimally utilize buffer capacity or increase line efficiency. In addition, the quantity of containers dispensed is not constant or defined. The containers are usually delivered in bulk and the delivery quantity is controlled by the pushing behavior on the line.

### Object

The object of the invention is to provide a method and an apparatus that make possible flexible and efficient control of a buffer apparatus.

### Solution

The object is achieved by the method and the apparatus according to the independent claims. Further embodiments are disclosed in the dependent claims.

A method for automatically controlling at least two drivable belts in a system, wherein the belts are each configured to transport containers in a first direction or a second direction, wherein the system comprises a machine that is upstream of the belts and/or a machine that is downstream of the belts, comprises:
detecting a first operating state of the upstream machine and/or
detecting a second operating state of the downstream machine,
determining a speed to be selected for each of the belts based on the first operating state and/or the second operating state,
controlling the belts according to the speed to be selected.

A direction (the first or second direction) and a speed value (magnitude of the speed) can be assigned to the speed to be selected.

Therefore, if there is an upstream and a downstream machine in the system, the first operating state of the upstream machine and the second operating state of the downstream machine are detected and the speeds of the belts to be selected are determined in each case based on the first operating state and the second operating state.

If there is only one upstream machine in the system, the first operating state of the upstream machine is detected and the speeds of the belts to be selected are determined based on the first operating state.

If there is only one downstream machine in the system, the second operating state of the downstream machine is detected and the speed of the belts to be selected is determined based on the second operating state.

Controlling the belts can also include closed-loop control.

The first direction and the second direction are oriented opposite to one another.

The belts can be regarded as a buffer apparatus since they can also have a buffering effect in a container transport process due to their ability to transport containers in a first direction or a second direction.

The first operating state can comprise a first transport speed and/or a first power, and the second operating state can comprise a second transport speed and/or a second power.

The first and second transport speeds can each be assigned a direction and a speed value (magnitude of speed).

The method can further comprise simulating a position of the containers in the system.

By simulating the position, it is possible to completely or largely dispense with the need to arrange light barriers or cameras in the system for monitoring purposes.

The simulation can further comprise evaluating sensor data from a sensor included in the system, for example data from a light barrier included in the system, or can further comprise using a default value from the downstream machine. The data from the light barrier can be used to check and provide closed-loop control of the simulation. The default value of a downstream machine can include a number of processable containers for a given machine state.

The determination of the speed to be selected can also be carried out based on a predetermined belt occupancy of each of the belts.

By taking the belt occupancy into account, it can be avoided, for example, that there are too many containers or rows of containers on one belt.

The determination of the speed to be selected can also be based on a predetermined number of containers that are to be delivered from the belts in each case.

For example, the number of containers to be delivered can take into account an increased or reduced performance of a machine following the belts.

The at least two drivable belts can be two consecutive belts.

The at least two drivable belts can be arranged in parallel. A first and a second belt can be provided which are arranged in parallel; that is to say, exactly two belts arranged in parallel. More than two parallel belts can also be provided.

In the case of at least two drivable belts arranged in parallel, the determination of the speed to be selected can further be based on a first path to be covered by a container on a first belt of the belts to a position downstream of the belts and on a path to be covered by a container on the other belts to the position.

A given total output rate of the belts can be based on a belt output rate for each belt, wherein the belt output rates can be different. The total output rate or the output rate can refer to a number of containers that can be dispensed by all belts or one of the belts.

For example, if exactly two belts are arranged in parallel, for a total output rate of 120%, one of the belts can be operated at an output rate of 100% and the other belt at an output rate of 140%.

The method can further comprise communication with a secondary buffer included in the system, which can be arranged downstream of the belts, for closed-loop control of the belts according to the speed to be selected in each case. The secondary buffer can be configured to be drivable, connected to the belts and also configured to transport containers in the first direction or the second direction.

Additional containers or rows of containers can be buffered on the secondary buffer during a system failure.

The containers can be arranged on the belts as rows of containers. The container rows can be maintained during a drive of the first/second belt in the first or second direction and during a standstill of the belts.

Alternatively, the containers can be arranged on the belts in a grouping in any arrangement, wherein, for example, a belt occupancy of containers per square meter can be the same.

An apparatus for automatically controlling at least two drivable belts in a system, wherein the belts are each configured to transport containers in a first direction or a second direction, wherein the system comprises a machine that is upstream of the belts and/or a machine that is downstream of the belts, is configured to carry out the method as described above or below.

For example, the apparatus can include stored instructions that, when executed by a processor of the apparatus, cause the apparatus to perform the method.

The at least two drivable belts can be two consecutive belts or the at least two drivable belts can be arranged in parallel. For example, exactly two parallel belts can be provided.

The apparatus can further comprise a time delay member. The time delay member can provide a temporal offset as to when the controlled speeds of each of the belts can begin.

If there are exactly two belts arranged in parallel, the time delay member can be used to enable the speed of the first belt to be selected and/or the speed of the second belt to be selected to start with a certain time delay, so that a difference in the length of a first path to be covered by a container on the first belt to a position downstream of the first and second belts and a second path to be covered by a container on the second belt to the position can be taken into account.

### BRIEF DESCRIPTION OF THE FIGURES

The accompanying figures show, by way of example, aspects and/or exemplary embodiments of the invention for better understanding and illustration. In the drawings:

FIG. 1 shows a schematic plan view of a first embodiment of the apparatus with two parallel, drivable belts with a feed conveyor belt and a discharge conveyor belt running transversely thereto,

FIG. 2 shows a block graph of an exemplary method for automatically controlling two parallel, drivable belts in a system,

FIG. 3A is a path-time graph of a plurality of rows of containers on the first belt,

FIG. 3B is a path-time graph of a plurality of rows of containers on the second belt,

FIG. 4A is a speed-time graph of the first belt,

FIG. 4B is a speed-time graph of the second belt,

FIG. 5A shows the percentage occupancy of a first belt as a function of time,

FIG. 5B shows the percentage occupancy of a second belt as a function of time,

FIG. 6A shows the cumulation of containers of a first belt as a function of time and linear regression thereto,

FIG. 6B shows the cumulation of containers of a second belt as a function of time and linear regression thereto,

FIG. 6C shows the sum of the cumulation of containers of the first and second belt as a function of time and linear regression thereto,

FIG. 7 is a schematic plan view of a second embodiment of the apparatus with four parallel, drivable belts with a feed conveyor belt and a discharge conveyor belt running transversely thereto, and

FIG. 8 is a schematic plan view of a third embodiment of the apparatus with two consecutive belts with a feed conveyor belt and a discharge conveyor belt running transversely thereto.

### DETAILED DESCRIPTION OF THE FIGURES

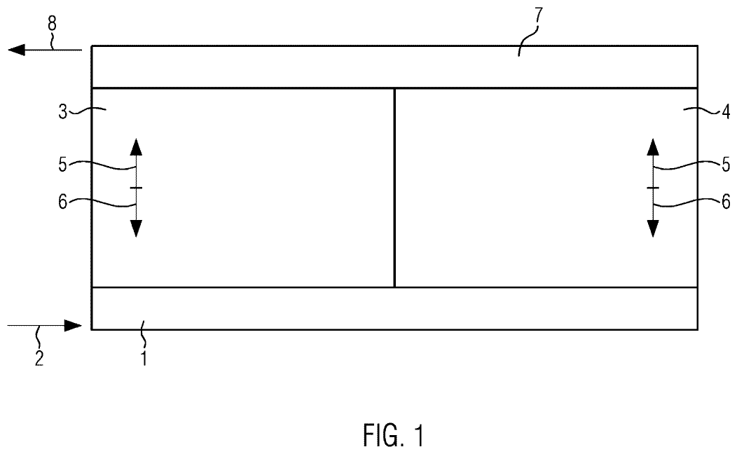

FIG. 1 shows a schematic plan view of a first embodiment of the apparatus with two parallel, drivable belts 3, 4 with a feed conveyor belt 1 running transversely thereto and a discharge conveyor belt 7 running transversely thereto. The two belts 3, 4 can each be driven in a first direction 5 and in a second direction 6 and are each configured to transport containers in the first or second direction 5, 6. The transporting can also include buffering of the containers. The first direction 5 and the second direction 6 are opposite to each other. The belts 3 and 4 can also remain stationary. The containers can be arranged in container rows, which can be retained during transport or buffering on the belts 3, 4. In the illustration, the feed conveyor belt 1 is moved in a third direction 2 and the discharge conveyor belt 7 in a fourth direction 8, wherein the third and fourth directions 2, 8 are opposite to each other. Alternatively, the feed conveyor belt 1 and the discharge conveyor belt 7 can also be transported in the same direction.

The belts 3, 4 can be included by a system, wherein the system can comprise a machine that is upstream of the belts 3, 4 and/or a machine that is downstream of the belts 3, 4. In a method for automatically controlling these two belts 3, 4, a first operating state of the upstream machine and/or a second operating state of the downstream machine can be detected, depending on their presence. The determination of a speed to be selected for each of the belts 3, 4 can be carried out based on the first and/or the second operating state. The control of the belts 3,4 can then be carried out according to the speed to be selected.

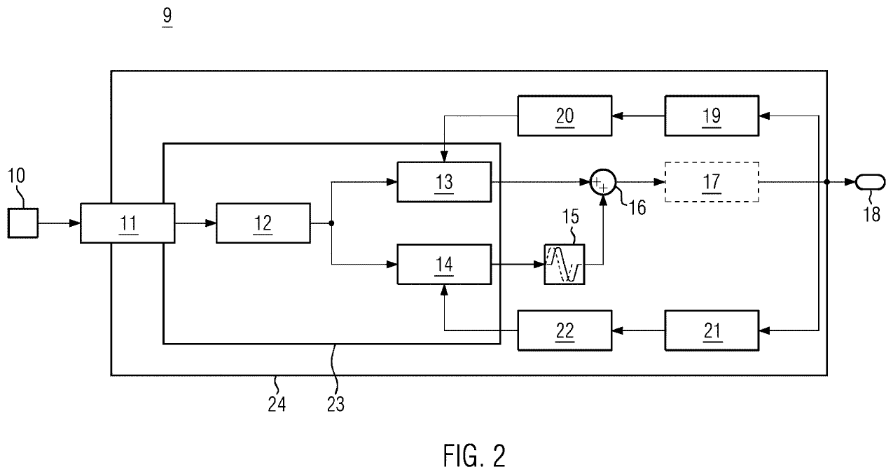

FIG. 2 shows a block graph 9 for an exemplary method for automatically controlling two parallel, drivable belts in a system. The system includes an inlet, a pasteurizer, a feed conveyor belt, the two belts, a buffer and a discharge conveyor belt. Data 10 concerning the inlet are transferred to the pasteurizer and data 11 from the pasteurizer to the feed conveyor. The pasteurizer can be considered here as a machine that is upstream of the first and second belts. Data 12 from the pasteurizer are transferred to the feed conveyor belt and data 12 from it to the first and second belt. The first speed of the first belt can be controlled or also closed-loop controlled by measured values 19 and the output 20 of a first actuator. Accordingly, the second speed of the second belt can be controlled or also closed-loop controlled by measured values 21 and the output 22 of a second actuator.

By way of example, a time delay member 15 is assigned to the second belt, to which data 14 of the second belt are fed. The time delay member 15 enables the second speed to start with a certain time delay so that a difference in the length of a first path to be covered by a container on the first belt to a position downstream of the first and second belts and a second path to be covered by a container on the second belt to the position can be taken into account.

Data 13 of the first belt and time-delayed data of the second belt are fed to an adder. The data 16 of the adder are fed to the buffer. The buffer can be viewed as a machine that is downstream of the first and second belts. Data 17 from the buffer can be transferred to the discharge conveyor 18.

Thus, by detecting a first operating state of the pasteurizer and detecting a second operating state of the buffer, it is possible to determine the first speed of the first belt and the second speed of the second belt based on the first operating state and the second operating state and to control the first and second belts accordingly.

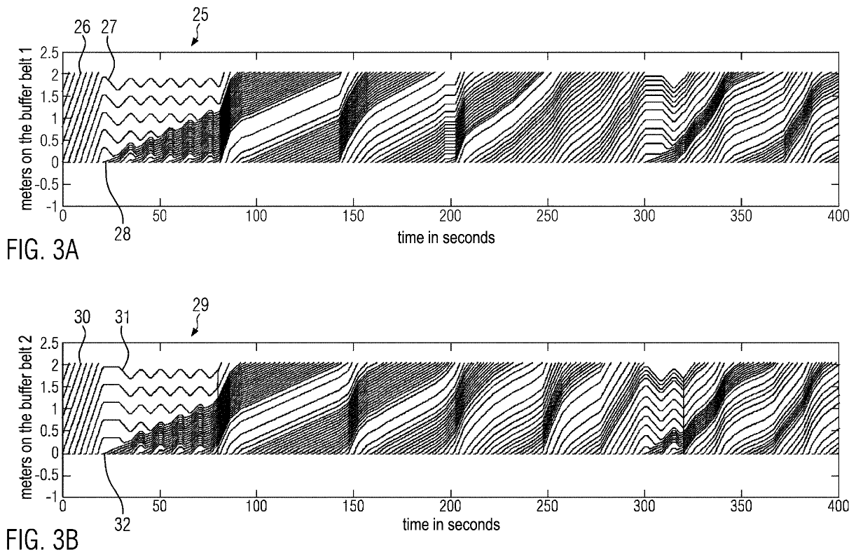

FIG. 3A shows a path-time graph 25 of a plurality of container rows on the first belt, which can thus be described, for example, by s(t) functions in each case. The path is given in meters, the time in seconds. The length of the first belt is, as an example, 2 meters. The lines shown in the graph, three of which are identified by reference numerals 26, 27, 28, each represent a row of containers that is transported on the first belt.

Transporting can be done by moving or stopping the first belt, for example moving/driving in the first direction (increase in the numerical value of the path) or the second direction (decrease in the numerical value of the path). The first belt can also remain stationary (constant numerical value of the path). The transporting can include a buffering of the container rows. The individual rows of containers can be retained at any time. The gradient (first derivative of the s(t) function) of the curves shown corresponds to the speed of the first belt.

If the first and second directions are assumed to be parallel to the y-direction, the length of the first belt is in the y-direction, the “path” represents the y-coordinate.

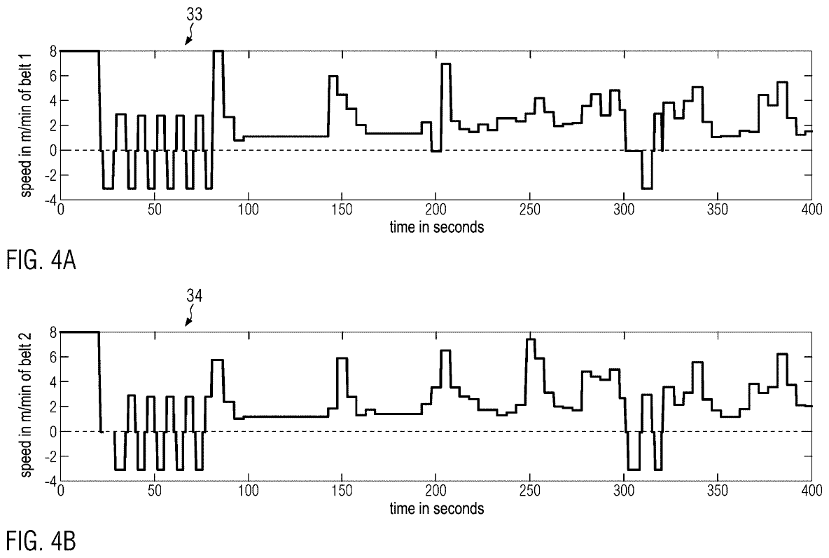

FIG. 4A shows the speed-time graph of the first belt corresponding to the path-time graph shown in FIG. 3A.

Between 0 seconds and 20 seconds the system is in normal operation. The numerical values of the paths of the individual container rows therefore show an increase. The container row 26 can leave the first belt during normal operation. The container row 27 is still on the first belt when, in the period from 20 seconds to 80 seconds, a first malfunction occurs in the system and a delivery of containers from the first belt is prevented by corresponding control of the first belt. However, during the malfunction, new containers can still be placed on the first belt and can be buffered together with the existing ones for the duration of the first malfunction. For example, container row 28 reaches the first belt after the start of the first malfunction.

It can be seen that after the beginning and during the first malfunction, the path of the container rows on the first belt decreases or remains the same, depending on whether the first belt is moved in the second or first direction or is stationary. Due to the change in direction, more rows of containers can reach the first belt than in normal operation, which can be seen, for example, in the reduction in the distance between the individual lines over a period of 20 to 80 seconds and a path of 0 to 0.5 meters.

At the time 80 seconds the first malfunction is eliminated and the containers cumulated on the first belt, i.e., the rows of containers, begin to be dismantled, i.e., they are transferred from the belt, for example, to the discharge apparatus. The belt occupancy is the same on both belts. The different positive gradients of the lines in different time periods mean that the first belt is moving at different speeds in the first direction. A gradient of zero, i.e., a constant numerical value of the path, means that the first belt is stationary (for example, at a time of about 200 seconds).

At the time of 300 seconds, a second malfunction occurs for a period of 20 seconds, so that the delivery of containers from the first belt is prevented by corresponding control of the first belt. However, during the malfunction, new containers can still be placed on the first and second belts, which can be buffered together with the existing ones for the duration of the second malfunction. The gradient of zero, i.e., a constant numerical value of the path, means that the first belt is stationary after the beginning of the second malfunction. Thereafter, the path of the container rows on the first belt decreases, remains the same for a short time and then increases, corresponding to a movement of the first belt in the second direction, a standstill and a movement in the first direction. Due to the change in direction, more rows of containers can reach the first belt than in normal operation, which can be seen, for example, in the reduction in the distance between the individual lines for example over a period of 310 to 320 seconds and a path of 0 to 0.25 meters.

At the time 320 seconds the second malfunction is eliminated and the containers cumulated on the first belt, i.e., the rows of containers, begin to be dismantled, i.e., they are transferred from the belt, for example, to the discharge apparatus. The different positive gradients of the lines in different time periods mean that the first belt is moving at different speeds in the first direction.

FIG. 3B shows a path-time graph 29 of a plurality of container rows on the second belt, which can thus be described, for example, by s(t) functions in each case, wherein the framework conditions correspond to those of FIG. 3A. The path is given in meters, the time in seconds. The length of the second belt is 2 meters. The lines shown in the graph, three of which are identified by reference numerals 30, 31, 32, each represent a row of containers that is transported on the second belt.

Transporting can be done by moving or stopping the second belt, for example moving/driving in the first direction (increase in the numerical value of the path) or the second direction (decrease in the numerical value of the path). The second belt can also remain stationary (constant numerical value of the path). The transporting can include a buffering of the container rows. The individual rows of containers can be retained at any time. The gradient (first derivative of the s(t) function) of the curves shown corresponds to the speed of the second belt.

If the first and second directions are assumed to be parallel to the y-direction, the length of the second belt is in the y-direction, the “path” represents the y-coordinate.

FIG. 4B shows the speed-time graph of the second belt corresponding to the path-time graph shown in FIG. 3B.

Between 0 seconds and 20 seconds the system is in normal operation. The numerical values of the paths of the individual container rows therefore show an increase. The container row 30 can leave the second belt during normal operation. The container row 31 is still on the second belt when, in the period from 20 seconds to 80 seconds, a first malfunction occurs in the system and a delivery of containers from the second belt is prevented by corresponding control of the second belt. However, during the malfunction, new containers can still be placed on the second belt and can be buffered together with the existing ones for the duration of the first malfunction. For example, container row 32 reaches the second belt after the start of the first malfunction.

It can be seen that after the beginning and during the first malfunction, the path of the container rows on the second belt remains the same or decreases depending on whether the second belt is stationary or is moved in the second or first direction. Due to the change in direction, more rows of containers can reach the second belt than in normal operation, which can be seen, for example, in the reduction in the distance between the individual lines over a period of 20 to 80 seconds and a path of 0 to 0.5 meters.

At the time 80 seconds the first malfunction is eliminated and the containers cumulated on the second belt, i.e., the rows of containers, are started to be dismantled, i.e., they are transferred from the belt, for example, to the discharge apparatus. The different positive gradients of the lines in different time periods mean that the second belt is moving at different speeds in the first direction.

At the time of 300 seconds, a second malfunction occurs for a period of 20 seconds, so that the delivery of containers from the second belt is prevented by corresponding control of the second belt. However, during the malfunction, new containers can still be placed on the second belt and can be buffered together with the existing ones for the duration of the first malfunction. After the start of the second malfunction, the path of the container rows on the second belt decreases, remains the same for a short time, then increases, remains the same for a short time, then decreases and remains the same for a short time, corresponding to a movement of the second belt in the second direction, a standstill, a movement in the first direction, a standstill, a movement in the second direction and a standstill. Due to the change in direction, more rows of containers can reach the second belt than in normal operation, which can be seen, for example, in the reduction in the distance between the individual lines over a period of 310 to 320 seconds and a path of 0 to 0.5 meters.

At the time 320 seconds the second malfunction is eliminated and the containers cumulated on the second belt, i.e., the rows of containers, begin to be dismantled, i.e., they are transferred from the belt, for example, to the discharge apparatus. The different positive gradients of the lines in different time periods mean that the second belt is moving at different speeds in the first direction.

FIG. 4A shows a speed-time graph 33 of the first belt, corresponding to the path-time graph of FIG. 3A. The speed is given in meters per minute, the time in seconds. The gradient (first derivative of the v(t) function) of the curve shown corresponds to the acceleration of the first belt.

During the period from 0 seconds to 20 seconds during which the system is in normal operation, the first belt is driven in the first direction at a speed of 8 meters per minute (8 m/min).

The first malfunction in the system occurs between 20 seconds and 80 seconds, and the delivery of containers from the first belt is prevented by controlling the first belt accordingly. The control can adjust the speed and its direction accordingly. Here, the first belt is initially slowed down as shown, so that the speed decreases from 8 m/min in the first direction until the belt comes to a temporary standstill. The first belt is then moved in the second direction until it reaches a speed of approximately-3 m/min. In general, a positive speed value corresponds to a speed in the first direction and a negative speed value corresponds to a speed in the second direction. This speed will be maintained for some time.

The first belt is then slowed down again as shown, so that the speed decreases from −3 m/min in the second direction. The first belt stops briefly before it is then driven in the first direction until it reaches a speed of about 3 m/min. Then the belt is slowed down so that the speed in the first direction decreases until the belt comes to a temporary standstill. The first belt is then moved in the second direction until it reaches a speed of approximately −3 m/min. This process takes place five times in the illustration as an example.

Then the first belt is slowed down again so that the speed decreases from −3 m/min in the second direction. The first belt is stationary for a short time before it is then driven in the first direction.

At the time 80 seconds the first malfunction is eliminated and the container rows cumulated on the first belt begin to be dismantled, i.e., they are transferred from the belt, for example, to the discharge apparatus. Therefore, the speed of the first belt in the first direction is increased to 8 m/min. Then, in the period up to 300 seconds, the first belt is driven at different speeds in the first direction or stopped for a certain period of time at a time of about 200 seconds.

The second malfunction in the system occurs between 300 seconds and 320 seconds, and the delivery of containers from the first belt is prevented by controlling the first belt accordingly. The belt is first slowed down, then stopped for a time, and then moved in the second direction, before being slowed down again, stopped for a time, and then moved in the first direction. At the time 320 seconds the second malfunction is eliminated and the container rows cumulated on the first belt are started to be dismantled, i.e., they are transferred from the belt, for example, to the discharge apparatus. For this purpose, the first belt is driven at different speeds in the first direction.

FIG. 4B shows a speed-time graph 34 of the second belt, corresponding to the path-time graph of FIG. 3B. The speed is given in meters per minute, the time in seconds. The gradient (first derivative of the v(t) function) of the curve shown corresponds to the acceleration of the second belt.

During the period from 0 seconds to 20 seconds during which the system is in normal operation, the second belt is driven in the first direction at a speed of 8 meters per minute (8 m/min).

The first malfunction in the system occurs between 20 seconds and 80 seconds, and the delivery of containers from the second belt is prevented by controlling the second belt accordingly. The control can adjust the speed and its direction accordingly. Here, the second belt is initially slowed down as shown, so that the speed decreases from 8 m/min in the first direction until the belt comes to a standstill for about 10 seconds. The second belt is accelerated in the second direction until it reaches a speed of approximately −3 m/min. This speed will be maintained for some time. In general, a positive speed value corresponds to a speed in the first direction and a negative speed value corresponds to a speed in the second direction.

The second belt is then slowed down again as shown, so that the speed decreases from −3 m/min in the second direction. The second belt stops briefly before it is then driven in the first direction until it reaches a speed of about 3 m/min. This speed will be maintained for some time. The second belt is then slowed down so that the speed in the first direction decreases until the belt comes to a temporary standstill. The second belt is accelerated in the second direction until it reaches a speed of approximately −3 m/min. This process takes place four times in the illustration as an example.

The second belt is then slowed down again as shown, so that the speed decreases from −3 m/min in the second direction. The second belt stops briefly before it is then driven in the first direction until it reaches a speed of about 3 m/min.

At the time 80 seconds the first malfunction is eliminated and the container rows cumulated on the second belt begin to be dismantled, i.e., they are transferred from the belt, for example, to the discharge apparatus. Therefore, the speed of the second belt is increased from 3 m/min to about 5.5 m/min. Afterwards, the second belt is driven at different speeds in the first direction in the period up to 300 seconds.

The second malfunction in the system occurs between 300 seconds and 320 seconds, and the delivery of containers from the second belt is prevented by controlling the second belt accordingly. The belt is first slowed down further, then is stationary for a short time and then moved in the second direction before it is slowed down again, is stationary for a short time and then accelerated in the first direction until it reaches a speed of 3 m/min. This speed is maintained for some time before the belt slows down, then stops for a short time and then moves in the second direction until it reaches a speed of −3 m/min.

At the time 320 seconds the second malfunction is eliminated and the container rows cumulated on the second belt begin to be dismantled, i.e., they are transferred from the belt, for example, to the discharge apparatus. To do this, the second belt is first slowed down, stands still for a short time and is then accelerated in the first direction and driven at different speeds in the first direction.

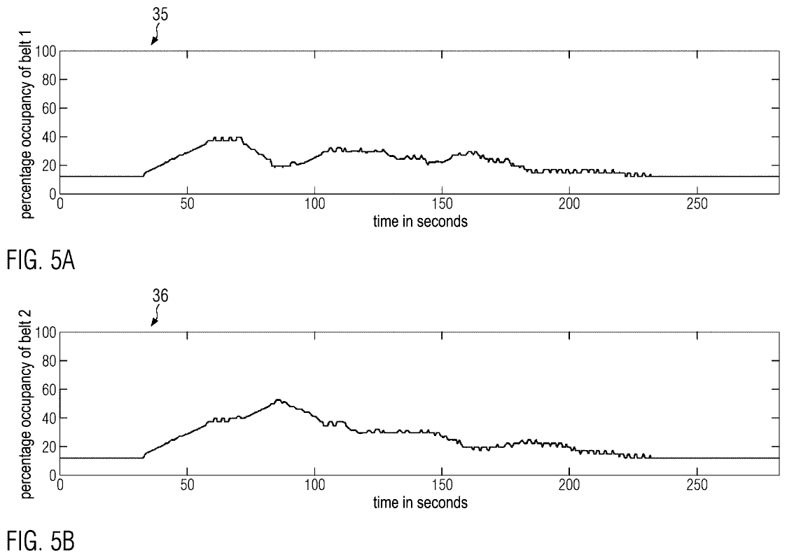

FIG. 5A shows a representation 35 of the percentage occupancy (belt occupancy) of a first belt as a function of time and FIG. 5B shows a representation 36 of the percentage occupancy (belt occupancy) of a second belt as a function of time, which is given in each case in seconds. During normal operation of the system, here in the period from 0 to about 30 seconds and from about 230 seconds, the percentage occupancy of the belts with containers is 12.5% in each case. During a malfunction, the percentage occupancy increases approximately linearly. On the other hand, a reduction in occupancy after a malfunction to a value of 12.5% occurs more unevenly. The reduction in the occupancy of the first and second belts can be carried out in such a way that subsequent machines are supplied with containers as optimally as possible.

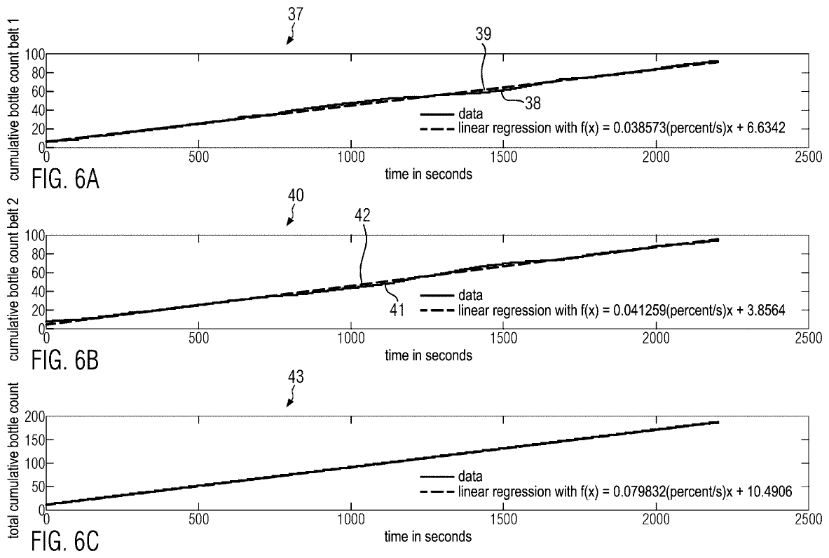

FIG. 6A shows a representation 37 of the cumulation of containers of a first belt as a function of time (indicated in seconds; abbreviated as s) and the linear regression thereto. The measured data are shown in the curve 38 and the linear regression in the straight line 39. For linear regression, the function f(x)=0.038573(percent/s)·x+6.6342 applies.

FIG. 6B shows a representation 40 of the cumulation of containers of a second belt as a function of time (indicated in seconds; abbreviated as s) and the linear regression thereto. The measured data are shown in the curve 41 and the linear regression in the straight line 42. For linear regression, the function f(x)=0.041259(percent/s)·x+3.8564 applies.

FIG. 6C shows a representation 43 of the sum of the cumulations of containers of the first and second belt as a function of time (in seconds; abbreviated as s) and the linear regression thereto. The measurement data and the linear regression agree to such an extent that no separate assignment of reference signs was made. For linear regression, the function f(x)=0.079832(percent/s)·x+10.4906 applies. A gradient of the line of 0.8 was expected.

The representation of the cumulation of containers shown in FIGS. 6A, 6B and 6C represents an exemplary state with exemplary speed limit values of 1 m/min and 8 m/min, respectively.

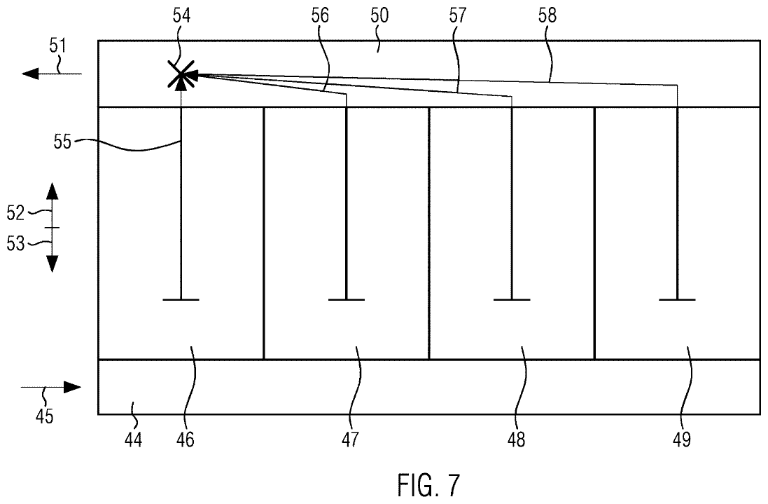

FIG. 7 shows a schematic plan view of a second embodiment of the apparatus with four parallel, drivable belts 46, 47, 48, 49 with a feed conveyor belt 44 and a discharge conveyor belt 50 running transversely thereto. The belts 46-49 can each be driven in a first direction 52 and in a second direction 53 and are each configured to transport containers in the first or second direction 52, 53. The transporting can also include buffering of the containers. The first direction 52 and the second direction 53 are opposite to each other. The belts 46-49 can also remain stationary. The containers can be arranged in container rows, which can be retained during transport or buffering on the belts 46-49. In the illustration, the feed conveyor belt 44 is moved in a third direction 45 and the discharge conveyor belt 50 in a fourth direction 51, wherein the third and fourth directions 45, 51 are opposite to each other. Alternatively, the feed conveyor belt 44 and the discharge conveyor belt 50 can also be transported in the same direction.

In order to determine the speeds of the belts to be selected, the paths 55, 56, 57, 58 that have to be covered by a container on the belts 46-49 to a position 54 downstream of the belts 46-49 in each case can also be taken into account. On a first belt 46 of the belts 46-49, a container has to travel the path 55 to the position 54 downstream of the belts 46-49, which is shorter than the path 58 that a container on a fourth belt 49 of the belts 46-49 has to travel to the position 54 downstream of the belts 46-49.

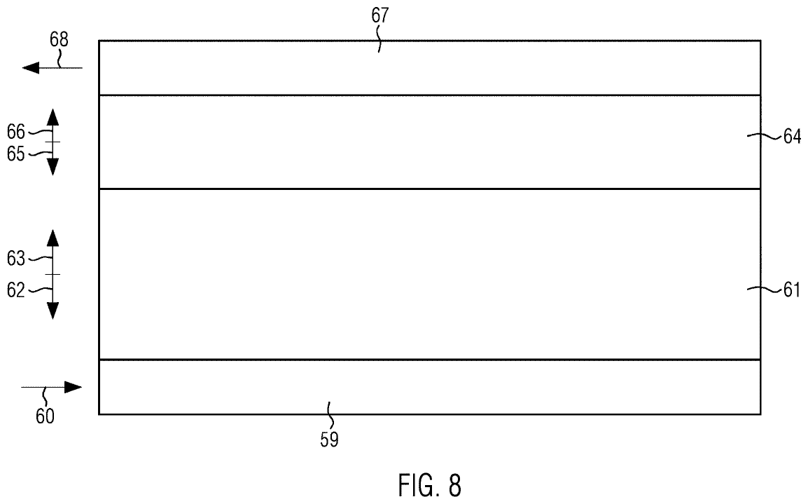

FIG. 8 shows a schematic plan view of a third embodiment of the apparatus with two consecutive belts 61, 64 with a feed conveyor belt 59 and a discharge conveyor belt 67 running transversely thereto. The first belt 61 can be driven in a first direction 63 and in a second direction 62 and is configured to transport containers in the first or second direction 63, 62. The transporting can also include buffering the containers. The first direction 63 and the second direction 62 are opposite to each other. The second belt 64 can be driven in a first direction 66 and in a second direction 65 and is configured to transport containers in the first or second direction 66, 65. The transporting can also include buffering the containers. The first direction 66 and the second direction 65 are opposite to each other. The belts 61 and 64 can also remain stationary. The containers can be arranged in container rows, which can be retained during transport or buffering on the belts 61, 64.

The second belt 64 is shown to be shorter than the first belt 61. The second belt 64 can be considered as a secondary buffer.

In the illustration, the feed conveyor belt 59 is moved in a third direction 60 and the discharge conveyor belt 67 in a fourth direction 68, wherein the third and fourth directions 60, 67 are opposite to each other. Alternatively, the feed conveyor belt 59 and the discharge conveyor belt 67 can also be transported in the same direction.

1. A method for automatically controlling at least two drivable belts in a system, wherein the belts are each configured to transport containers in a first direction or a second direction, wherein the system comprises a machine that is upstream of the belts and/or a machine that is downstream of the belts, wherein the method comprises:
detecting a first operating state of the upstream machine and/or
detecting a second operating state of the downstream machine,
determining a speed to be selected for each of the belts based on the first operating state and/or the second operating state,
controlling the belts according to the speed to be selected in each case.

2. The method according to claim 1, wherein the first operating state comprises a first transport speed and/or a first power, and wherein the second operating state comprises a second transport speed and/or a second power.

3. The method according to claim 1, further comprising:
simulating a position of the containers in the system.

4. The method according to claim 1, wherein the simulating further comprises:
evaluating sensor data from a sensor included in the system, wherein the sensor data comprises data from a light barrier included in the system, or using a default value from the downstream machine.

5. The method according to claim 1, wherein the determination of the speed to be selected is further carried out based on a predetermined belt occupancy of each of the belts.

6. The method according to claim 1, wherein the determination of the speed to be selected is further carried out based on a predetermined number of containers which are to be delivered by the belts in each case.

7. The method according to claim 1, wherein the at least two drivable belts are two consecutive belts.

8. The method according to claim 1, any wherein the at least two drivable belts are arranged in parallel.

9. The method according to claim 8, wherein the determination of the speed to be selected is further based on a first path to be covered by a container on a first of the belts to a position downstream of the belts and on a path to be covered by a container on the other belts to the position in each case.

10. The method according to claim 8, wherein a predetermined total output rate of the belts is based on an output rate of the belts in each case, wherein the output rates are different.

11. The method according to claim 8, further comprising communication with a secondary buffer included in the system, which is arranged downstream of the belts, for closed-loop control of the belts according to the speed to be selected.

12. The method according to claim 1, wherein the containers are arranged on the belts as container rows.

13. An apparatus for automatically controlling at least two drivable belts in a system, wherein the belts are each configured to transport containers in a first direction or a second direction, wherein the system comprises a machine that is upstream of the belts and/or a machine that is downstream of the belts, wherein the apparatus is configured to carry out the method according to claim 1.

14. The apparatus according to claim 13, wherein the at least two drivable belts are two consecutive belts, or wherein the at least two drivable belts are arranged in parallel.

15. The apparatus according to claim 13, or further comprising a time delay member.
